(19) United States
(12) Patent Application Publication
(10) Pub. No.: US 2003/0115473 A1
(43) Pub. Date: Jun. 19, 2003

(54) Biometrics authentication system and method

(75) Inventors: Masahiko Sugimura, Kawasaki (JP); Naoki Sashida, Kawasaki (JP); Hiroki Kitagawa, Kawasaki (JP); Masaki Watanabe, Kawasaki (JP)

Correspondence Address: STAAS & HALSEY LLP, 700 11TH STREET, NW, SUITE 500, WASHINGTON, DC, 20001, US

(73) Assignee: FUJITSU LIMITED, Kawasaki (JP)

(21) Appl. No.: 10/101,848

(22) Filed: Mar. 21, 2002

(30) Foreign Application Priority Data
Dec. 14, 2001 (JP) 2001-380816

(51) Int. Cl. H04K 1/00

(52) U.S. Cl. 713/186

(57) ABSTRACT

A biometrics authentication method includes: conducting authentication of a user by a method other than biometrics authentication; registering and storing biometrics data regarding a user; determining whether or not biometrics authentication can be conducted by referring to stored biometrics data; conducting biometrics authentication; and outputting an authentication result as to whether the user is authenticated, wherein biometrics data on the user is registered and stored only in the case where the user is authenticated by the method other than the biometrics authentication, and biometrics authentication is conducted only in the case where it is determined that biometrics authentication can be conducted.

### BACKGROUND OF THE INVENTION

1. Field of the Invention

The present invention relates to a biometrics authentication system and method applicable to the fields requiring the authentication of an individual by an apparatus, such as financial trading, purchase of goods, provision of application service provider (ASP) service, electronization of administrative procedures in the electronic government, and outsourcing of corporate database management, in the Internet environment.

2. Description of the Related Art

The most widespread individual authentication system in a computer system is a password system, which is implemented in various fields such as access to an intra-company network and service at an automatic teller machine (ATM) of the bank. According to the password system, in most cases, a user sets his/her password by using numbers easy for the user to remember, such as his/her birthday and telephone number, so as to avoid forgetting the password. Therefore, it is difficult to completely exclude an unauthorized access. The password system has such a potential problem.

Furthermore, under the conditions that the Internet environment has widely spread to ordinary households, and a number of network services dealing with individual financial assets, such as Internet banking, are being provided, there is an increased demand for the authentication of an individual. As an authentication system that is becoming mainstream in place of the password system, a digital certificate issuing system is considered.

According to the digital certificate issuing system, a digital certificate issued by a third party that provides credibility is stored in a user's personal computer, and only an owner of the digital certificate can receive authentication as a user. However, if the personal computer storing the digital certificate is stolen, there is a possibility that similar problems to those of the password system may occur.

In addition to these authentication systems, there is a tendency that the case of adopting a biometrics authentication system is increasing. Herein, the biometrics authentication refers to a system for conducting the authentication of an individual based on physical feature portions of a user: biological information such as a fingerprint, an iris, and so on.

In biometrics authentication, authentication is targeted for biological information peculiar to a human. Therefore, unlike the password system, it is not required for a user to be aware of identification information such as a password, and such biological information cannot be lent to the others and cannot be shared between the user and the others. Thus, the effect of suppressing crimes can be expected.

On the other hand, according to the biometrics authentication, there is a possibility that a user may feel a psychological resistance. An input device is required for inputting biometrics data, and in addition, an authentication precision may be varied due to the changes in state of the input device and environment, so that tension may be forced on a user during input of data. Furthermore, there may be the cases where authentication cannot be exactly conducted due to the change in biological information, such as an outer damage caused by an accident and a change in physical condition or the like.

As described above, there is a tendency that an authentication strength is decreased due to the changes in state of an input device, environment, physical condition of a user, and state of a user. In order to solve such a problem, it is conceivable to enrich registered biometrics data of a user. In other words, rich registered biometrics data means that the data contains sufficient variations for absorbing changes in environment and user.

However, in order to obtain sufficient data by one registration, it is required to set a registration facility for artificially creating variations, and to ask a user to visit the facility. Alternatively, in the case where registration is conducted at user's home, it is required for the user to conduct various operations for creating variations, which puts a considerable burden on the user. Specific examples of operations to be the burden on the user include an enroll operation and the like at a voice recognition application. These operations lead to an increase in psychological resistance of the user with respect to the use of the application, which may become an obstacle for introducing a biometrics authentication system itself.

Even if attempts are made to increase variations by one registration, it may be impossible to sufficiently grasp the change in use environment of a user and the change in state of a user.

### SUMMARY OF THE INVENTION

Therefore, with the foregoing in mind, it is an object of the present invention to provide a biometrics authentication system or method capable of registering biometrics data reflecting the change in use environment of a user and the change in physical condition and state of a user with less burden on the user, and conducting authentication by sufficiently utilizing the biometrics data.

In order to achieve the above-mentioned object, the biometrics authentication system of the present invention includes: an authentication information input part for inputting information for authenticating a user; a first authenticating part for authenticating the user by a method other than biometrics authentication; a biometrics data registering part for registering and storing biometrics data on the user; a second authenticating part for conducting biometrics authentication; a biometrics authentication possibility determining part for determining whether or not it is possible to use the second authenticating part by referring to the biometrics data stored in the biometrics data registering part; and an authentication result output part for outputting an authentication result as to whether the user is authenticated, wherein, only in a case where the user is authenticated in the first authenticating part, the biometrics data on the user is registered and stored in the biometrics data registering part, and only in a case where the biometrics authentication possibility determining part determines that it is possible to use the second authenticating part, the biometrics authentication using the second authenticating part is further conducted.

Because of the above-mentioned configuration, biometrics data on a user can be efficiently collected without putting a large burden on the user, and biometrics data sufficient for flexibly addressing the change in use environment of a user and the change in state of a user can be collected.

It is preferable in the biometrics authentication system of the present invention that the biometrics authentication possibility determining part determines that it is possible to use the second authenticating part in a case where a false rejection rate (FRR), a false acceptance rate (FAR), or both the rates is lower than a predetermined threshold value. This is because it can be expected that authentication based on biometrics data has a predetermined precision.

It is preferable that the biometrics authentication system of the present invention further includes: a determination notifying part for notifying the user of a determination result in the biometrics authentication possibility determining part; and a selection information receiving part for receiving selection information of an authentication system by the user, wherein the user selects authentication from the group consisting of authentication other than the biometrics authentication using the first authenticating part, the biometrics authentication using the second authenticating part, and a combination of the authentication other than the biometrics authentication using the first authenticating part and the biometrics authentication using the second authenticating part. This is because user's intention can be reflected.

It is preferable in the biometrics authentication system of the present invention that, in a case where a user is not change before and after the authentication of the user in the first authenticating part, biometrics data on the user is obtained after the user is authenticated in the first authenticating part, and the obtained biometrics data on the user is registered and stored in the biometrics data registering part.

Alternatively, it is preferable that the biometrics data on the user is obtained before the user is authenticated by the first authenticating part, and the obtained biometrics data on the user is registered and stored in the biometrics data registering part after the user is authenticated by the first authenticating part.

Alternatively, it is preferable that, in the case where a user may be changed before and after the authentication in the first authenticating part, under the condition that a time required for authentication in the first authenticating part is sufficiently short, the biometrics data on the user is obtained simultaneously when the user is authenticated by the first authenticating part, and the obtained biometrics data on the user is registered and stored in the biometrics data registering part. In any method, it can be exactly verified that biometrics data to be obtained is the one of a user.

It is also preferable in the biometrics authentication system of the present invention that there are a plurality of kinds of biometrics data to be registered. This is because a user can be authenticated with a higher precision.

Furthermore, the present invention is directed to a biometrics authentication method, including: inputting information for authenticating a user; authenticating the user by a method other than biometrics authentication; registering and storing biometrics data on the user; conducting biometrics authentication; determining whether or not it is possible to conduct the biometrics authentication by referring to the stored biometrics data; and outputting an authentication result as to whether the user is authenticated, wherein, only in a case where the user is authenticated in the operation of authenticating the user by a method other than the biometrics authentication, the biometrics data on the user is registered and stored, and only in a case where it is determined that it is possible to conduct the biometrics authentication, the biometrics authentication is further conducted. The present invention is also directed to a recording medium storing a computer-executable program for realizing the above-mentioned operations.

These and other advantages of the present invention will become apparent to those skilled in the art upon reading and understanding the following detailed description with reference to the accompanying figures.

### BRIEF DESCRIPTION OF THE DRAWINGS

FIG. 1 is a block diagram showing a biometrics authentication system of an embodiment according to the present invention.

FIG. 2 is a graph showing a false rejection rate (FRR) and a false acceptance rate (FAR) with respect to a matching distance.

FIG. 3 is a block diagram showing a biometrics authentication system of an embodiment according to the present invention.

FIG. 4 is a flow chart illustrating processing in the biometrics authentication system of an embodiment according to the present invention.

FIG. 5 illustrates a screen display in the case where the biometrics authentication system of an example according to the present invention is applied to electronic government service.

FIG. 6 illustrates a computer environment.

### DESCRIPTION OF THE PREFERRED EMBODIMENTS

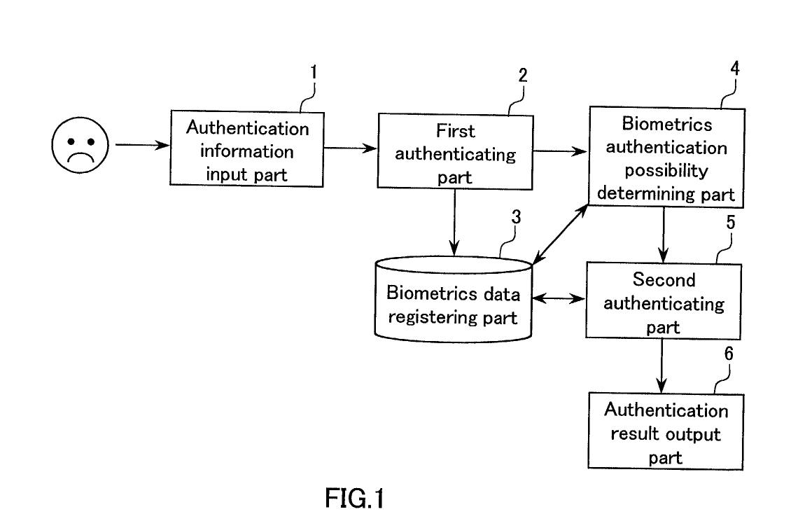

Hereinafter, the biometrics authentication system of an embodiment according to the present invention will be described with reference to the following drawings. FIG. 1 shows a configuration of the biometrics authentication system of the embodiment according to the present invention.

In FIG. 1, reference numeral 1 denotes an authentication information input part for inputting information to be required for authenticating a user. The authentication information input part includes, for example, not only input media such as a keyboard and a mouse, but also input equipment of biometrics data such as a camera and a fingerprint scanner, and a driver, a program, and the like for controlling these pieces of equipment.

Various methods can be considered for obtaining biometrics data. According to the most general method, a user is requested to input biometrics data and actively conducts an input operation. This method needs to be conducted, for example, in the case of obtaining biological information peculiar to a user such as a fingerprint, and so on.

There is also a method for obtaining biometrics data while notifying a user of that biometrics data is being obtained or without such notification. This method is effective with respect to biometrics data that is not required to be actively input by a user, such as face picture data, and does not put a burden on a user for registration.

In a case where service used by a user is accompanied by input of biometrics data, a method is conceivable in which data input during use of the service is directly registered. According to this method, in the case where communication is required between a user and a system providing the service, a user's uttered voice, a user's face picture, and the like are obtained automatically. Thus, it is possible to collect biometrics data without putting a burden on a user for registration of biometrics data. An example of such service includes voice portal service, face-to-face service through a TV telephone, and so on.

Reference numeral 2 denotes a first authenticating part for authenticating a user by a general authentication method other than biometrics authentication. For example, a method using a password, a method using a digital certificate, and the like may be used. However, the present invention is not particularly limited thereto.

Reference numeral 3 denotes a biometrics data registering part for registering and storing biometrics data (biological information) of a user. As biometrics data, a picture, a voice, and the like recorded in an analog data format or in a digital data format, or a feature value for authentication extracted from the data may be used. There is no particular limit to a recording medium for storing the data. For example, a general storage apparatus and the like can be used.

Biometrics data (biological information) of a user may be obtained at any of the following timings: biometrics data is obtained after a user is authenticated by the first authenticating part; biometrics data is obtained before a user is authenticated by the first authenticating part; and biometrics data is obtained when a user is authenticated by the first authenticating part. The first and second timings are predicated on that a user is not changed between a timing at which a user is authenticated and a timing at which biometrics data is obtained. The third timing has an advantage that it is ensured that a user is not changed between a timing at which a user is authenticated and biometrics data is obtained.

Reference numeral 4 denotes a biometrics authentication possibility determining part. The biometrics authentication possibility determining part 4 refers to the biometrics data registering part 3, and determines whether or not authentication (hereinafter, referred to as “biometrics authentication”) using biometrics data can be conducted in accordance with the state of the stored biometrics data.

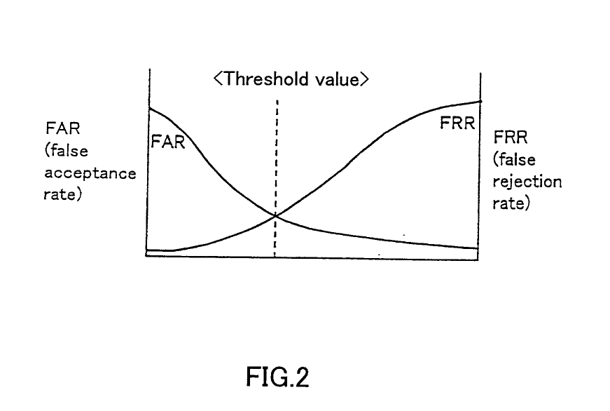

More specifically, the biometrics authentication possibility determining part 4 determines that biometrics data sufficient for authenticating a user has been accumulated in the case where a FRR and a FAR are converged in a predetermined range as shown in FIG. 2.

Generally, in the case where a user is authenticated based on the similarity of biometrics data, when a threshold value with respect to the similarity is represented by a horizontal axis, and a FRR (a rate at which a user is rejected erroneously) and a FAR (a rate at which a cheater is accepted erroneously) are represented by a vertical axis, a graph as shown in FIG. 2 is obtained.

As shown in FIG. 2, when the threshold value with respect to the similarity is set to be a small value, the FRR is decreased, while the FAR is increased. In contrast, when the threshold value with respect to the similarity is set to be a large value, the FAR is decreased, while the FRR is increased. Therefore, it is desirable to set the threshold value of the similarity at an appropriate value in accordance with the importance of two error rates.

In the case where the threshold value of the similarity is adjusted, and the FRR and the FAR fall in a range set by a system administrator, it is determined that biometrics data sufficient for authenticating a user has been accumulated.

It is also conceivable that the above-mentioned determination is based on the distribution and spread of biometrics data (digital data input through a device or a feature value for authentication extracted therefrom).

For example, there are a method for checking the variety of phonemes in registered data in the case of speaker authentication based on voice data, a method for detecting the face direction from registered data in the case of face picture authentication and checking the variety of the face direction, and the like.

Reference numeral 5 denotes a second authenticating part for authenticating a user based on biometrics data accumulated in the biometrics data registering part 3. Biometrics authentication in the second authenticating part 5 may be authentication with respect to one kind of biometrics data, or a combination of authentication with respect to a plurality of kinds of biometrics data.

For example, the following is possible: in the authentication information input part 1, face picture data and voice date are simultaneously obtained, and in the biometrics authentication possibility determining part 4, data determined to be usable for authenticating a user is successively subjected to an authentication operation.

Reference numeral 6 denotes an authentication result output part for presenting an authentication result to a user. There is no particular limit to an output method. The authentication result may be displayed on a display apparatus or output as a voice using a loudspeaker or the like.

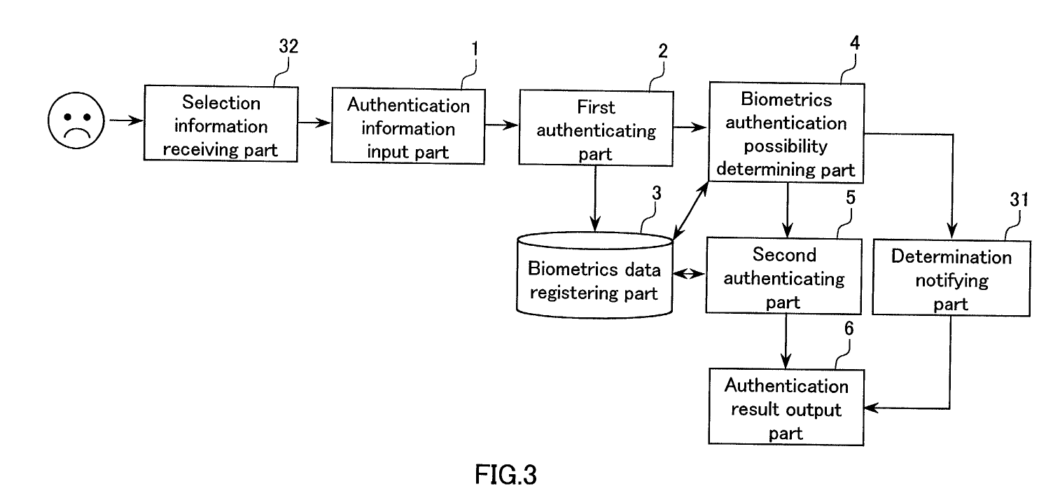

Furthermore, a system may be configured so that a user can select an authentication system, as shown in FIG. 3. FIG. 3 is a block diagram showing a biometrics authentication system of an embodiment according to the present invention in which an authentication system can be selected. In FIG. 3, reference numeral 31 denotes a determination notifying part, and 32 denotes a selection information receiving part.

The determination notifying part 31 notifies a user of a determination result in the biometrics authentication possibility determining part 4 as to whether the biometrics authentication can be conducted. As a notification method, in addition to the method of directly outputting the determination result to the authentication result output part 6, notification through electronic mail or the like can be considered.

The selection information receiving part 32 receives information indicating which authentication system is used by a user. More specifically, when a user confirms in the determination notifying part 31 that the second authenticating part 5 can be used, based on the determination result in the biometrics authentication possibility determining part 4 as to whether the biometrics authentication can be conducted, the user can select either one of an authentication system using only the first authenticating part 2, an authentication system using only the second authenticating part 5, or an authenticating system using both the authenticating parts.

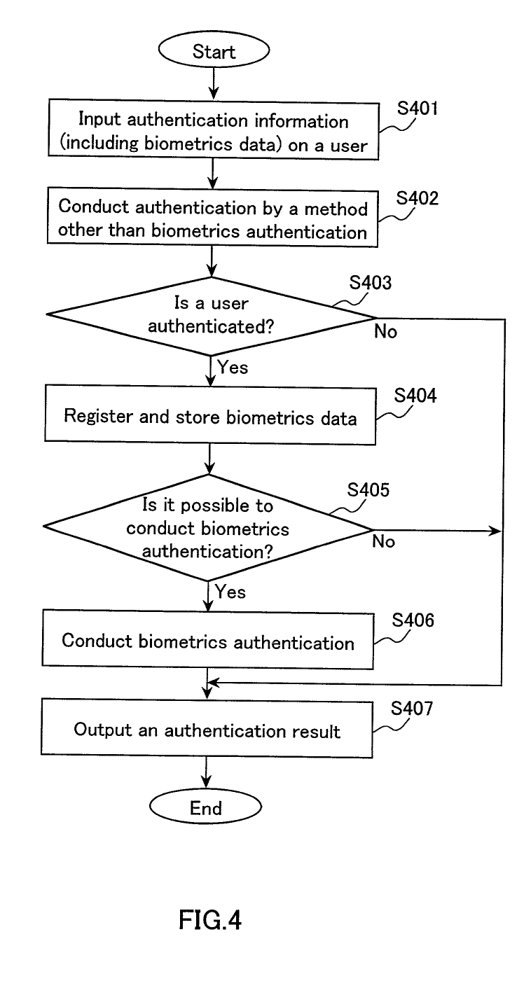

Next, a processing flow of a program for realizing a biometrics authentication system of an embodiment according to the present invention will be described. FIG. 4 is a flow chart showing processing of a program for realizing the biometrics authentication system of the embodiment according to the present invention.

In FIG. 4, first a user inputs information that includes biometrics data and is required for authenticating the user (Operation 401). Such an input operation may be intentionally or unintentionally conducted by a user.

Next, authentication using an authentication system other than biometrics authentication, such as a password system and a digital certificate system, is conducted (Operation 402). In the case where the user is not authenticated (Operation 403: No), such an authentication result is output (Operation 407).

In the case where the user is authenticated (Operation 403: Yes), the input biometrics data is registered and stored (Operation 404). It is determined whether or not biometrics authentication can be conducted (Operation 405). This determination is conducted by referring to the registered biometrics data to determine whether or not biometrics data is accumulated to such a degree that biometrics authentication is conducted sufficiently, or by referring to the previous determination result.

In the case where it is determined that biometrics authentication can be conducted (Operation 405: Yes), biometrics authentication is conducted (Operation 406), and an authentication result is output (Operation 407).

As described above, in the present embodiment, biometrics data verified to be the one of a user can be collected efficiently without putting a large burden on the user, and biometrics data sufficient for flexibly addressing the change in use environment of a user and the change in state of a user can be collected.

Next, the case where the biometrics authentication system of the present embodiment is applied to electronic government service will be described by way of an example. Herein, the “electronic government service” refers to service which allows a user to access a public organization such as a city hall from a home terminal, and to conduct official procedures such as application, authentication, issuance, and browsing, while communicating with an operator. Thus, in this example, biometrics authentication is conducted using face picture data.

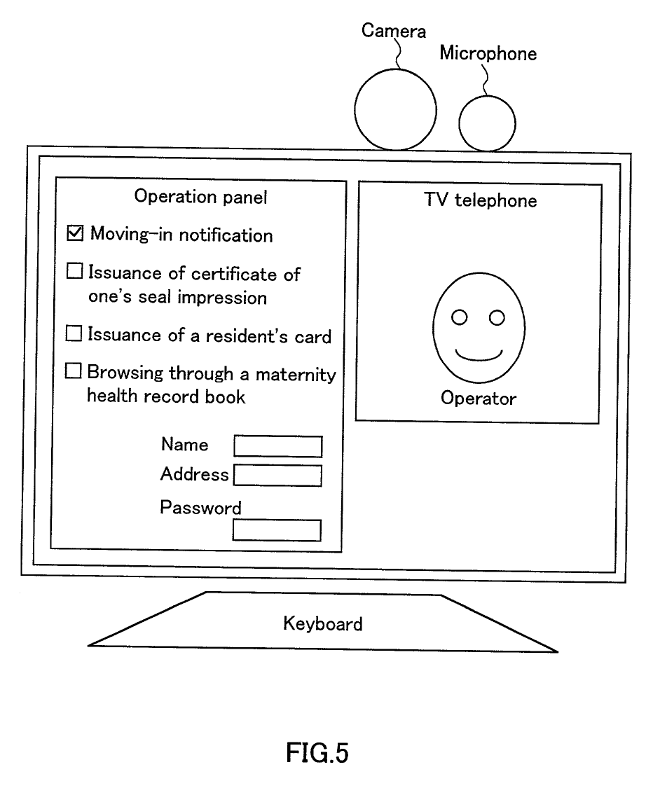

FIG. 5 is an image view showing a service providing terminal and a screen displayed at the terminal used for the above-mentioned service. At the service providing terminal shown in FIG. 5, in addition to a keyboard, input media for collecting biometrics data such as a camera and a microphone are disposed. On the display screen, a TV telephone panel for communicating with an operator, an operation panel for inputting information for service selection and procedures, and a password are disposed. The display screen is not particularly limited to the present example. An unattended system requiring no operator may be used.

Hereinafter, a flow of processing of introducing face picture authentication in the case where a user desires a shift from password authentication to face picture authentication will be described. Herein, the processing will be described in the case where a user accesses service for the purpose of issuance of a resident's card.

First, when a user starts communicating with an operator by inputting a user ID, a TV telephone image on a user side is accumulated as biometrics data during communication. When authentication based on a password is conducted in the course of an issuance procedure, the accumulated picture data is registered as face picture data of the user, and the user receives a resident's card.

Then, regarding the registered face picture data of the user, a variation in a face direction (e.g., minimum 75°), and a variation in time of obtaining data (e.g., night and daytime) are checked. It is assumed in this stage that it is determined that sufficient biometrics data has not been registered.

In the case where the user accesses the service regarding another case at a later date, authentication based on a password is conducted again, and registration of face picture data is continued. At this point, when it is determined that face picture data sufficient for authenticating a face picture has been registered, face picture authentication becomes effective at the subsequent accesses.

More specifically, in the case where the user accesses the service regarding another case at a further later date, the user is authenticated by face picture authentication without inputting a password, and can receive desired service.

The biometrics authentication system of the present embodiment according to the present invention can use voice data as well as face picture data. For example, the biometrics authentication system of the present embodiment is also applicable to voice portal service and the like through a mobile phone. Herein, the voice portal service provides a user with interactive service utilizing voice recognition. Various services including browsing through a time table and a bank transfer are considered.

It may also be considered that a palm print peculiar to each user is used as biometrics authentication data. For example, the biometrics authentication system is applicable to a system that introduces palm print authentication into unlocking of a door. More specifically, a palm print scanner is built in a door knob so that a palm print can be scanned when a user grasps the door knob. Because of this, in the same way as in electronic government service, a user can automatically unlock a door only by grasping a door knob without unlocking the door, after several times of unlocking by the user.

The biometrics authentication system is also applicable to log-in to a general computer. Thus, the biometrics authentication system is applicable to all the systems requiring authentication of a user.

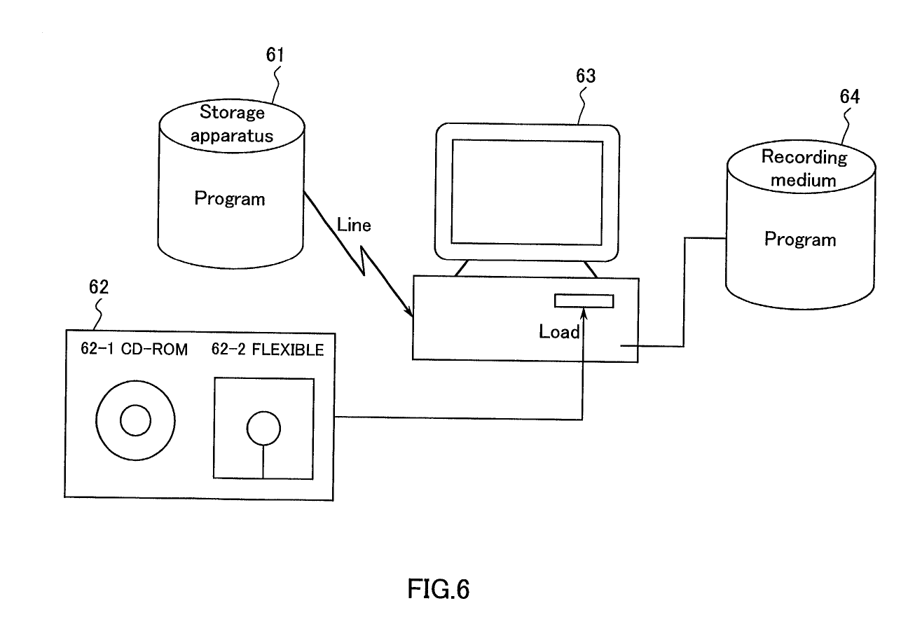

A program for realizing the biometrics authentication system of the embodiment according to the present invention may be stored in a storage apparatus 61 provided at the end of a communication line and a recording medium 64 such as a hard disk and a RAM of a computer 63, as well as a portable recording medium 62 such as a CD-ROM 62-1 and a flexible disk 62-2, as shown in FIG. 6. In execution, the program is loaded, and executed on a main memory.

Examples of a recording medium storing registered biometrics data and the like accumulated by the biometrics authentication system of the embodiment according to the present invention may include a storage apparatus 61 provided at the end of a communication line and a recording medium 64 such as a hard disk and a RAM of a computer 63, as well as a portable recording medium 62 such as a CD-ROM 62-1 and a flexible disk 62-2, as shown in FIG. 6. For example, the recording medium is read by a computer 63 when the biometrics authentication system of the present invention is used.

As described above, in the biometrics authentication system of the present invention, biometrics data verified to be the one of a user can be collected efficiently without putting a large burden on the user, and biometrics data sufficient for flexibly addressing the change in use environment of a user and the change in state of a user can be collected.

The invention may be embodied in other forms without departing from the spirit or essential characteristics thereof. The embodiments disclosed in this application are to be considered in all respects as illustrative and not limiting. The scope of the invention is indicated by the appended claims rather than by the foregoing description, and all changes which come within the meaning and range of equivalency of the claims are intended to be embraced therein.

What is claimed is:

1. A biometrics authentication system, comprising:
an authentication information input part for inputting information for authenticating a user;
a first authenticating part for authenticating the user by a method other than biometrics authentication;
a biometrics data registering part for registering and storing biometrics data on the user;
a second authenticating part for conducting biometrics authentication;
a biometrics authentication possibility determining part for determining whether or not it is possible to use the second authenticating part by referring to the biometrics data stored in the biometrics data registering part; and
an authentication result output part for outputting an authentication result as to whether the user is authenticated,
wherein, only in a case where the user is authenticated in the first authenticating part, the biometrics data on the user is registered and stored in the biometrics data registering part, and
only in a case where the biometrics authentication possibility determining part determines that it is possible to use the second authenticating part, the biometrics authentication using the second authenticating part is further conducted.

2. A biometrics authentication system according to claim 1, wherein the biometrics authentication possibility determining part determines that it is possible to use the second authenticating part in a case where a false rejection rate (FRR) is lower than a predetermined threshold value.

3. A biometrics authentication system according to claim 1, wherein the biometrics authentication possibility determining part determines that it is possible to use the second authenticating part in a case where a false acceptance rate (FAR) is lower than a predetermined threshold value.

4. A biometrics authentication system according to claim 2, wherein the biometrics authentication possibility determining part determines that it is possible to use the second authenticating part in a case where a false acceptance rate (AR) is lower than a predetermined threshold value.

5. A biometrics authentication system according to claim 1, further comprising:
a determination notifying part for notifying the user of a determination result in the biometrics authentication possibility determining part; and
a selection information receiving part for receiving selection information of an authentication system by the user,
wherein the user selects authentication from the group consisting of authentication other than the biometrics authentication using the first authenticating part, the biometrics authentication using the second authenticating part, and a combination of the authentication other than the biometrics authentication using the first authenticating part and the biometrics authentication using the second authenticating part.

6. A biometrics authentication system according to claim 1, wherein biometrics data on the user is obtained after the user is authenticated in the first authenticating part, and the obtained biometrics data on the user is registered and stored in the biometrics data registering part.

7. A biometrics authentication system according to claim 1, wherein the biometrics data on the user is obtained before the user is authenticated by the first authenticating part, and the obtained biometrics data on the user is registered and stored in the biometrics data registering part after the user is authenticated by the first authenticating part.

8. A biometrics authentication system according to claim 1, wherein the biometrics data on the user is obtained simultaneously when the user is authenticated by the first authenticating part, and the biometrics data is registered and stored in the biometrics data registering part.

9. A biometrics authentication system according to claim 1, wherein there are a plurality of kinds of the biometrics data to be registered.

10. A biometrics authentication system according to claim 2, wherein there are a plurality of kinds of the biometrics data to be registered.

11. A biometrics authentication system according to claim 3, wherein there are a plurality of kinds of the biometrics data to be registered.

12. A biometrics authentication system according to claim 4, wherein there are a plurality of kinds of the biometrics data to be registered.

13. A biometrics authentication system according to claim 5, wherein there are a plurality of kinds of the biometrics data to be registered.

14. A biometrics authentication system according to claim 6, wherein there are a plurality of kinds of the biometrics data to be registered.

15. A biometrics authentication system according to claim 7, wherein there are a plurality of kinds of the biometrics data to be registered.

16. A biometrics authentication system according to claim 8, wherein there are a plurality of kinds of the biometrics data to be registered.

17. A biometrics authentication method, comprising:
inputting information for authenticating a user;
authenticating the user by a method other than biometrics authentication;
registering and storing biometrics data on the user;
conducting biometrics authentication;
determining whether or not it is possible to conduct the biometrics authentication by referring to the stored biometrics data; and
outputting an authentication result as to whether the user is authenticated,
wherein, only in a case where the user is authenticated in the operation of authenticating the user by a method other than the biometrics authentication, the biometrics data on the user is registered and stored, and
only in a case where it is determined that it is possible to conduct the biometrics authentication, the biometrics authentication is further conducted.

18. A recording medium storing a computer-executable program for realizing a biometrics authentication method, the program comprising the operations of:
inputting information for authenticating a user;
authenticating the user by a method other than biometrics authentication;
registering and storing biometrics data on the user;
conducting biometrics authentication;
determining whether or not it is possible to conduct the biometrics authentication by referring to the stored biometrics data; and
outputting an authentication result as to whether the user is authenticated,
wherein, only in a case where the user is authenticated in the operation of authenticating the user by a method other than the biometrics authentication, the biometrics data on the user is registered and stored, and
only in a case where it is determined that it is possible to conduct the biometrics authentication, the biometrics authentication is further conducted.
